(19) United States
(12) Patent Application Publication
(10) Pub. No.: US 2010/0058446 A1
(43) Pub. Date: Mar. 4, 2010

(54) INTERNET MONITORING SYSTEM

(76) Inventor: RICHARD D. THWAITES, GRAPEVINE, TX (US)

Correspondence Address: GARLICK HARRISON & MARKISON, P.O. BOX 160727, AUSTIN, TX, 78716-0727, US

(21) Appl. No.: 12/429,980

(22) Filed: Apr. 24, 2009

Related U.S. Application Data
(60) Provisional application No. 61/092,052, filed on Aug. 26, 2008.
(60) Provisional application No. 61/142,416, filed on Jan. 5, 2009.

(51) Int. Cl. G06F 21/00; G06F 15/16; G06F 15/173

(52) U.S. Cl. 726/4; 709/224; 709/225

(57) ABSTRACT

A method and apparatus support defining user monitoring and restriction parameters; restricting usage in accordance with the restriction parameters; and reporting usage. More specifically, access to web sites is blocked if listed as a blocked site or if usage of a web site or web site category has exceeded a specified daily limit. The system specifically supports generation of displays to allow an administrator to select usage by web site or category in relation to the day of the week. Further, the administrator can define categories by specific web addresses and can specify search terms and associated blocking logic.

### CROSS-REFERENCE TO RELATED PATENT APPLICATIONS

The present U.S. Utility patent application claims priority pursuant to 35 U.S.C. § 119(e) to the following U.S. Provisional Patent Applications which are hereby incorporated herein by reference in their entirety and made part of the present U.S. Utility patent application for all purposes:
1. U.S. Provisional Application Ser. No. 61/092,052, entitled “Internet Monitoring System,” (Attorney Docket No. FAMI001P1), filed Aug. 26, 2008, pending; and
2. U.S. Provisional Application Ser. No. 61/142,416, entitled “Internet Monitoring System,” (Attorney Docket No. FAMI001P2), filed Jan. 5, 2009, pending.

### BACKGROUND OF THE INVENTION

1. Technical field of the Invention

The present application relates to a system and apparatus for monitoring and regulating Internet usage.

2. Description of Related Art

The Internet is a global network of interconnected computers that allow users to communicate, share information, work together in a collaborative manner, and with the newest versions of broadband access to the Internet, to receive streaming media at a data rate that supports television type viewing for entertainment.

A computer connects to the Internet through a local service provider that provides the communication path between a user's computer and a server that is coupled to the Internet. As such, a user can access information from a vast array of servers and computers by downloading information for storage or display. This access, however, is by way of a large number of interconnected computers. Computer users typically use web browsers, email programs, chat programs and file transfer programs to interact with remote computers via the network of interconnected computers.

The interconnected computer networks communicate using packet switching protocols according to the Internet Protocol Suite (TCP/IP). TCP/IP is a “network of networks” that consists of millions of private and public, academic, business, and government networks of local to global scope that are linked by all types of physical communication paths. Physical media for conducting or supporting such communications include copper wires (e.g., telephone lines, cable lines, etc.) and fiber-optic cables. Additionally, wireless communication channels are being developed with sufficiently high bandwidth to support the high data rate communications including wireless transmission of streaming media for high definition television applications.

The first TCP/IP-based wide-area network was operational in 1983 when a system known as ARPANET was introduced. In 1988, networks using TCP/IP protocols were introduced for commercial usage. As the TCP/IP network protocols became increasingly popular, a variety of networks became operably coupled to support more expansive computer communications. Because TCP/IP works over most pre-existing communication networks, its growth in usage and popularity along with the implementation of commercial routers using TCP/IP allowed the Internet to flourish.

References to the World Wide Web are references to the Internet as well as the compilation of data in the form of text files, document files, image files and audio files that may be accessed through use of hyperlinks or Uniform Resource Locators (URLs). URLs, effectively, are world wide web addresses used to connect to a specified web page or document.

Web services have evolved to use the Internet to allow software systems to communicate in order to share and exchange business logic and data and for the delivery of services. Users typically use a search engine to find or access a particular web site that provides a specified service. The search engines typically utilize keyword-driven applications in which web sites specifically list keywords that might be used to discover their web site. Search engine companies, to support fast results for user's search efforts, conduct automated and manual searches of web sites for such keywords that are then stored in an organized manner to quickly provide search results for a user.

With these technologies, information sharing and global ideal sharing has exploded. Today, it is very easy to publish a web page for individuals and organizations at a very low cost. Moreover, social networking sites have recently flourished in which individuals can post personalized web pages to facilitate meeting others having common interests or to promote political and social ideals, or even to advertise one's availability for specialized services or employment. The Internet has thus greatly expanded the mechanisms for social interaction due to its widespread connectivity that has so expanded communication.

Today, the rapid development of the Internet and its linking to wireless cellular networks are leading, interestingly, to generational differences in communications approaches. One generation may largely prefer the telephone while another generation prefers the widespread use of email to supplement telephone usage while yet another generation may largely prefer using chat rooms and text messages to communicate.

Because of all of the communication options that now exist, and because of the ability of individuals to access private computer networks over the Internet, new ways of working from home and even of educating students are evolving. Similarly, entertainment and delivery of entertainment is changing. The computer, which was once nothing but a work tool, has now become an entertainment device especially because of increase communications capabilities. With the advent of streaming media, not only can people work from home, but can be entertained at home in ways that were not possible before. For example, many existing radio and television broadcasters provide Internet “feeds” of their shows or programming. The range of material that can be found on the Internet is extensive and includes family oriented content and content that is inappropriate for some.

Because the Internet has brought about such change to our forms of business, entertainment, and communication, many use the Internet and their computers more than ever, and, perhaps more than they should. Not only might employees spend too much time during work hours “web surfing”, but children may spend too much time on the social network websites or they may access web sites that they should not. Generally, employees and/or children may spend too much time enjoying the aspects of communication and entertainment that are provided by the Internet. What is needed is a system for regulating access to the Internet that achieves the goals of a parent or employer as well as the user.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

A better understanding of the present invention can be obtained when the following detailed description of the preferred embodiment is considered with the following drawings, in which:

FIG. 1 is a diagram that illustrates an example display of set up page.

FIGS. 2A and 2B are diagrams that illustrate an example display of restriction definitions page elements.

FIG. 3 is a diagram that illustrates an example usage report.

FIG. 4 is a diagram that illustrates an example display of category definitions by web site.

FIG. 5 is a flow chart according to one embodiment of the invention.

FIG. 6 is a flow chart according to one embodiment of the invention.

FIG. 7 is a functional block diagram of a monitoring system according to one embodiment of the invention.

FIG. 8 is a device according to one embodiment of the invention.

FIG. 9 is a functional block diagram of a monitoring and access control system that includes a blocking module.

FIG. 10 is a diagram of a network according to one embodiment of the invention.

FIG. 11 is a flow chart of a method according to one embodiment of the invention.

FIG. 12 is diagram that illustrates an example display of restriction definitions page elements that allows an administrator to specify search terms and associated logic for unknown web sites that a user is attempting to access.

### DETAILED DESCRIPTION OF THE INVENTION

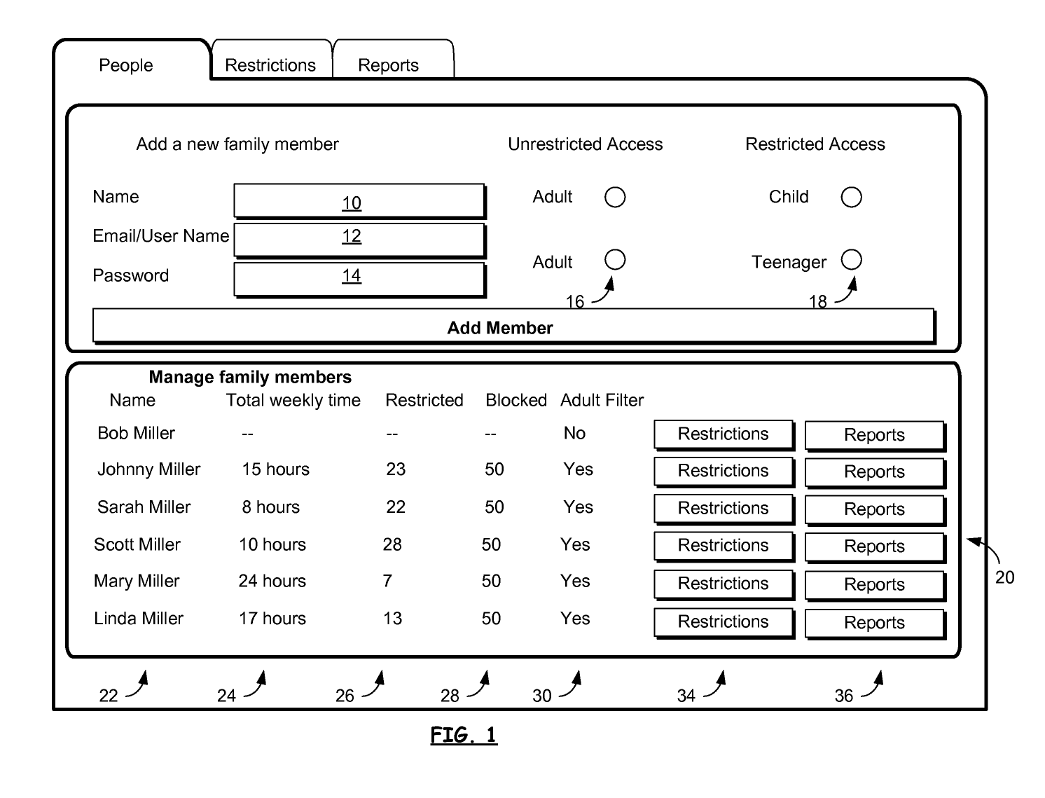

FIG. 1 is a diagram that illustrates an example display of a set up page for establishing access controls for a user. While the particular examples illustrated in FIG. 1 as well as the subsequent figures are directed to family usage, it should be understood that these described embodiments may be used in the workplace (including educational institutions) also. In the described embodiment of FIG. 1, the setup page allows entry of a name or user name, an email address and a password. In another embodiment, one or more instant messaging user names may also be identified. Additionally, graphical user interface (GUI) options are presented to allow an administrator to define the allowable type of usage (restricted or non-restricted). As may also be seen, a display 20 includes a listing of usage restrictions per user and some characteristics of usage for each user of a group (e.g., a family). While this display 20 of total usage restrictions is shown on the same page as the GUI page for adding family members, it should be understood that the display of total usage restrictions may be arranged differently and separately.

In FIG. 1, GUI fields 10-14 generated by a local or remote server application allows a user (e.g., an administrator with corresponding access levels) to add or identify family members by name, email or user name and an assigned password and to add or modify usage restrictions through selection of selectable GUI fields 16-18. Display 20 includes a column 22 of family member names, a column 24 of total hours of usage allowed, a column 26 of a number of restricted sites, a column 28 of a number of blocked sites, a column 30 that indicates whether an adult filter is applied to the family member, a column 34 for selecting restriction parameters, and a column 36 for selecting a report or report parameters for the family member. The column fields in a row are for associated column elements. Thus, each of the column fields on the row for Sarah Miller, for example, corresponds to usage restrictions defined the columns for Sarah Miller. Thus, for example, Sarah is only allowed 8 hours of total Internet time.

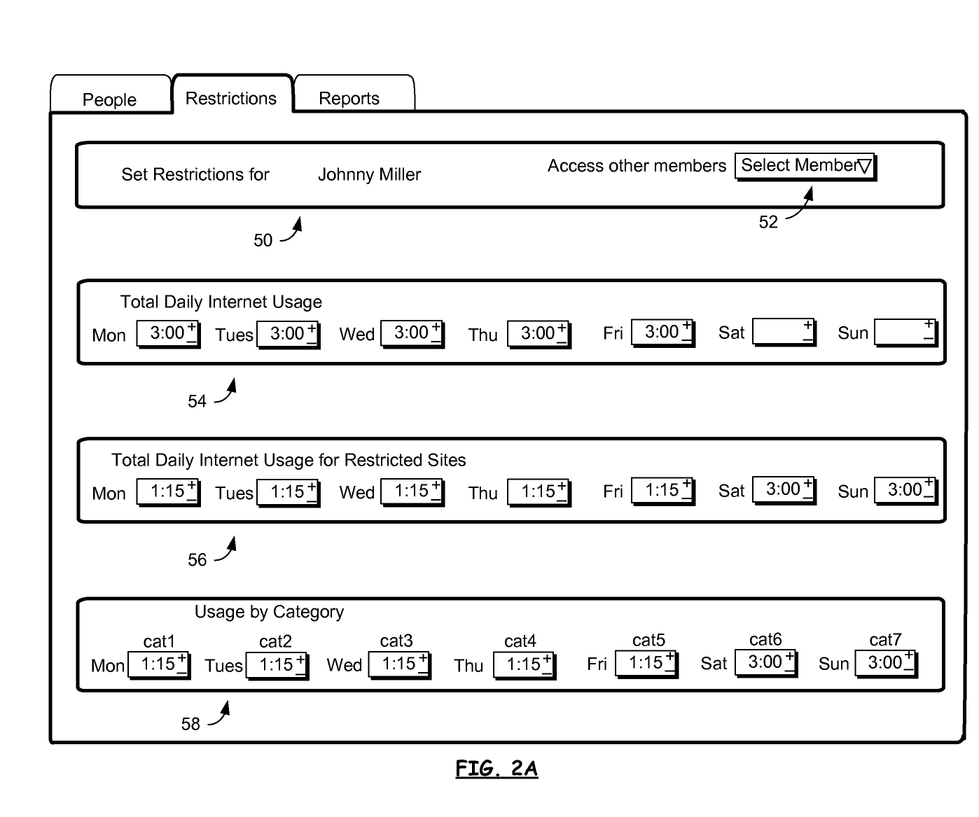

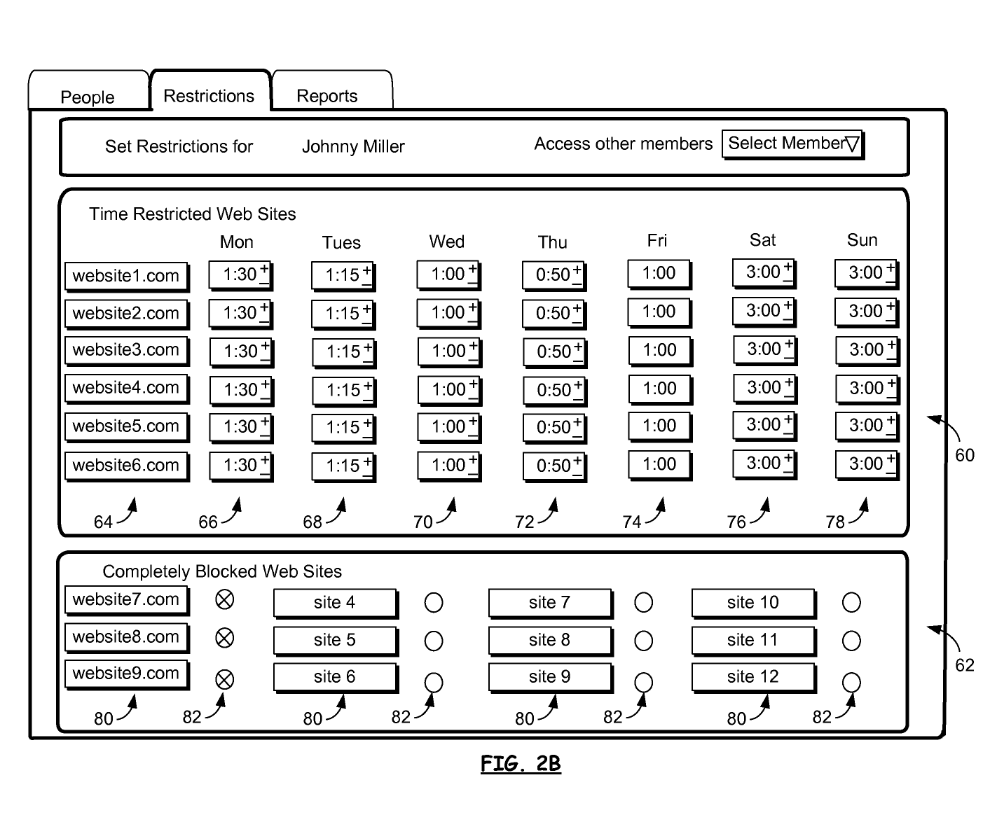

FIG. 2A is a diagram that illustrates an example display of restriction definitions page for total hours. Thus, if the “Restrictions” selectable GUI button of column 34 of FIG. 1 is selected for Johnny Miller, a display window 50 is generated identifying Johnny Miller as the family member whose restrictions are being added or modified. Here, display window 50 includes a pull down list 52 to allow other family members to be selected for restriction access entry or modification. A window shown generally at 54 includes a plurality of GUI fields, one for each day of the week, to allow an administrator to specify total usage on a daily basis. As may be seen, total usage is unlimited on weekends since the limit value was left blank by the administrator. In one embodiment of the invention, a window 56 allows the administrator to specify at total amount of usage time per day for restricted sites. Similarly, a window 58 allows the administrator to specify at total amount of usage time per day for categories of web sites. For this embodiment, an associated window or page is displayed to allow the administrator to customize category definitions.

FIG. 2B is a diagram that illustrates an example display of restriction definitions page for total hours that is specified not only by day, but also by web site. Windows shown generally at 60 and 62 allow an administrator to define usage restrictions or blocking for associated web sites, respectively. A window shown generally at 60 allows an administrator to specify web site addresses that are to have restricted usage and their corresponding restrictions. For example, the GUI fields of column 64 allow the administrator to enter specific web site names (address) that are to be restricted. Columns 66-78 then include GUI fields that correspond to the days of the week to allow the administrator to specify usage restrictions per day per web site. A window shown generally at 62 allows an administrator to specify web site addresses that are to be completely blocked. Web sites that may be completely blocked may be specified in the GUI fields shown at 80. Each of the identified web sites that are blocked has an associated blocked indicator shown generally at 82.

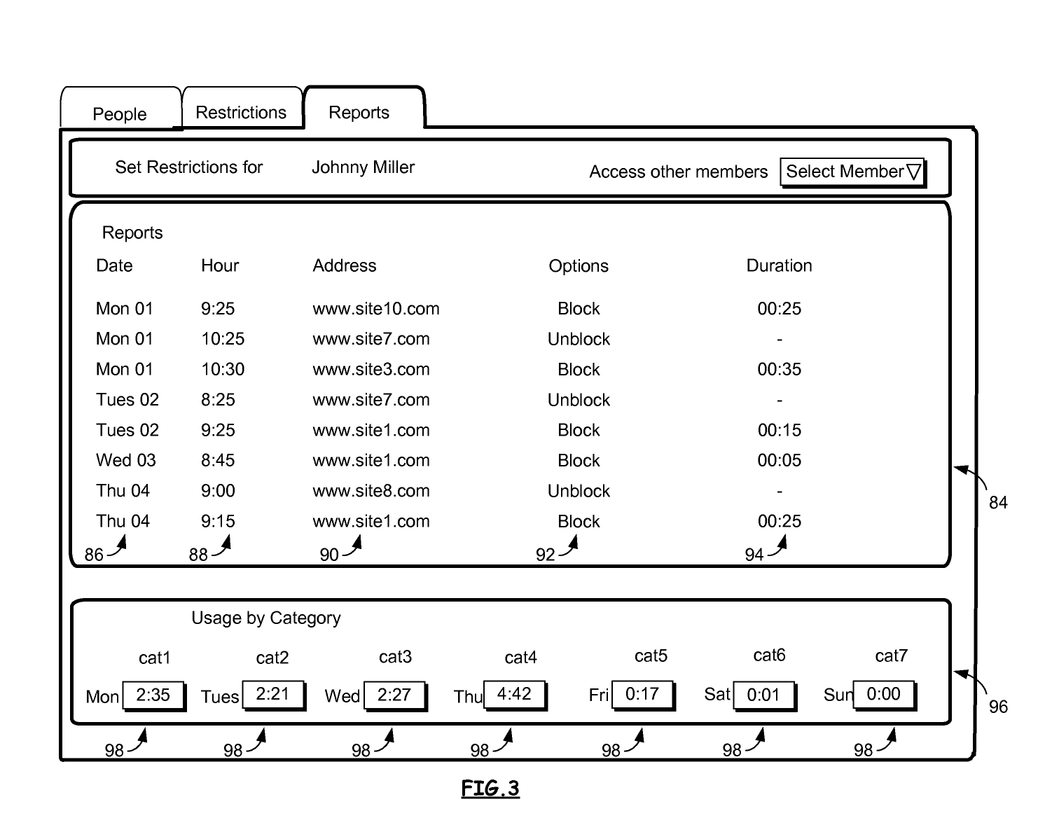

FIG. 3 is a diagram that illustrates an example usage report. As may be seen, for a given user, the usage report lists usage on a per web site address basis in a window 84. Thus, the date is shown in fields of column 86, the attempted or actual time of access to the web site is shown in column 88. The web site name or address is shown in column 90. Selectable options to block or unblock a web site are shown in column 92. Finally, the duration of each access is shown in column 94. The usage report, optionally, also displays usage totals in relation to categories of web sites. A window 96 lists total usage by category and day in fields shown at 98.

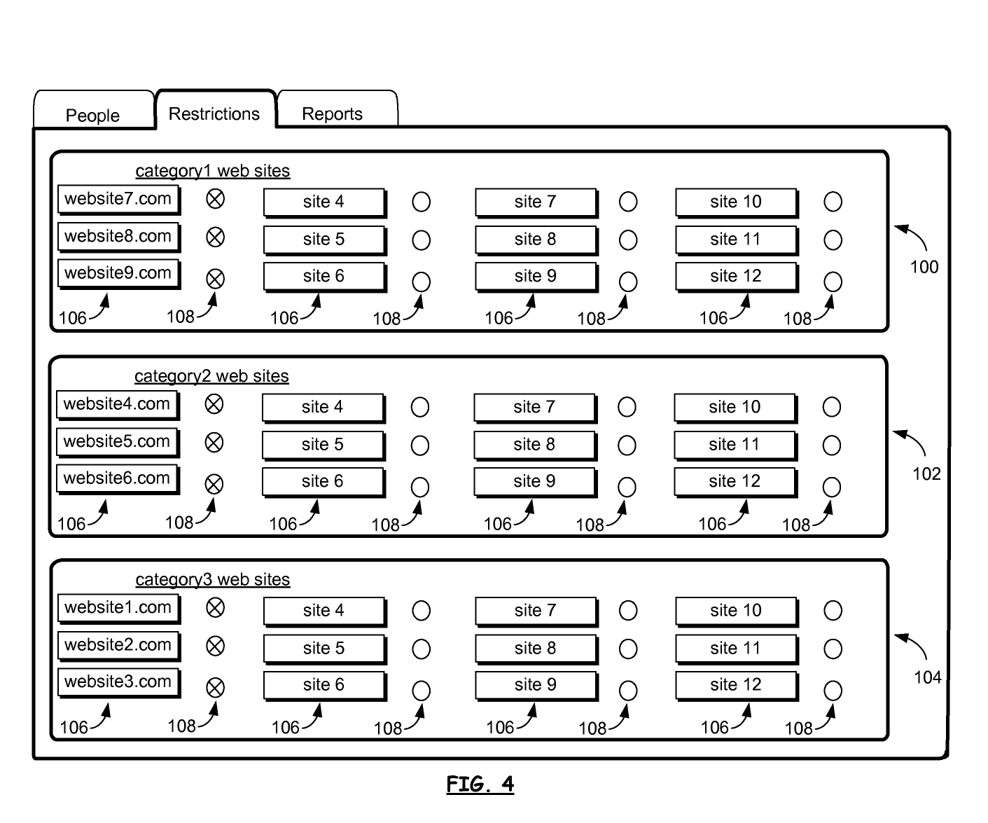

FIG. 4 is a diagram that illustrates an example display of category definitions by web site. Windows shown generally at 100-104 allow an administrator to define web site category associated web sites, respectively. In one embodiment, a user assigns a name to a category and then specifies associated web sites. Thus, as shown in window 100, three websites (website7.com, website8.com and website9.com) are included in category1 web sites. The website addresses are entered into the GUI fields shown at 106. The administrator then may select the selectable fields shown at 108 to include or remove a web site without having to delete the web site address. This allows web site addresses to be temporarily removed from a category definition and then easily included again. FIG. 4 is exemplary. Additional windows similar to windows 100-104 may be included. Moreover, in one embodiment, if an administrator chooses a known category name such as “Social Networking”, a server that generates a GUI page similar to the one of FIG. 4 is operable to automatically populate the GUI fields 106 with a list of known social networking sites to allow the administrator to select, deselect or remove such web site address. Accordingly, the embodiments of the invention may include category based usage restrictions, usage blocking, and reporting.

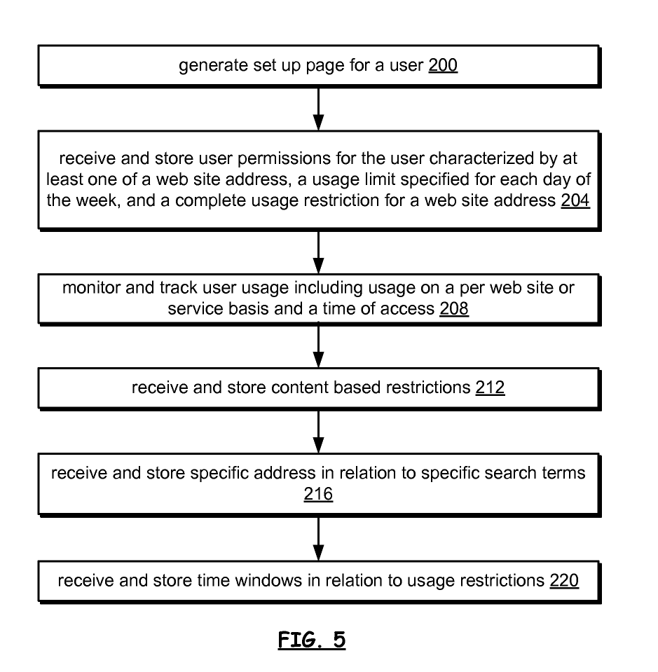

FIG. 5 is a flow chart according to one embodiment of the invention. The method includes generating a setup page for a user (200), receiving user permissions (204), monitoring (208), receiving and storing content based restrictions (212), receiving specific addresses in relation to specified search terms (216), receive and store time windows or ranges specific to usage related restrictions (220). These restrictions can be for specific web sites or for categories of web sites.

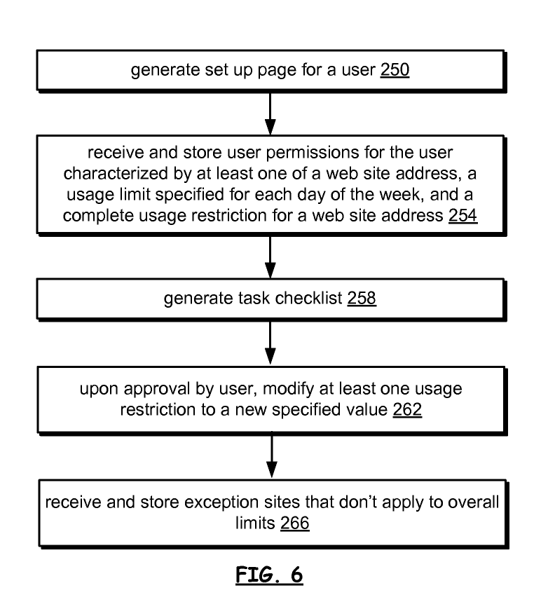

FIG. 6 is a flow chart according to one embodiment of the invention. The method includes generating a setup page for a user for completion by an administrator (250), receiving user permissions (254), generating a task checklist (258), receiving task list approval by the user, and modifying at least one usage restriction to a new value (262). The method also includes receiving and storing exception sites and/or categories that to apply to overall limits (266). In step 266, an administrator can specify web sites or addresses that are not a part of the usage restrictions. Such sites can include, for example, school web sites, financial account web sites, religious based web sites, etc.

The task list of 258 is one that is generated by an administrator that the user must certify as being complete prior to gaining access to a defined list of web sites or categories of web sites prior to having the usage restrictions for such web sites changed to a new value. Thus, upon user certification by the user that the task list is complete, at least one restriction is modified accordingly. For example, if the task list includes completing math homework, access restrictions to social networking web sites may not be modified on a temporary basis until the user certifies that the math homework and other items on the task list are complete.

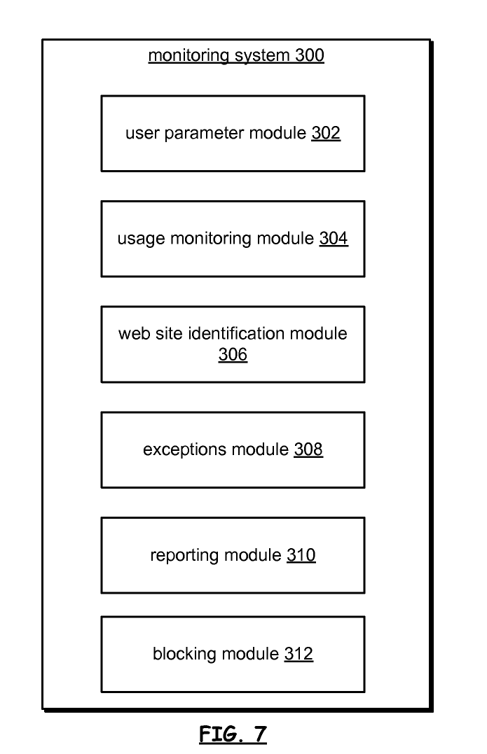

FIG. 7 is a functional block diagram of a monitoring system according to one embodiment of the invention. Each of the modules performs associated tasks to support the methods steps and prior described operations. Thus, the user parameter module 302 stores and processes usage access restrictions on a per user basis. The usage monitoring module 304 thus monitor usage and attempted usage for web sites as well as categories of web sites. The web site identification module 306 examines a web address for which access is desired and communicates with the user parameter module 302, an exceptions module 308, and a reporting module 310 and/or a blocking module 312 according to the web site address and/or category. For example, module 306 produces the web site address and, if known, a web site category to user parameter module 302. Module 302 then evaluates to determine if there are corresponding access restrictions.

If the category is a restricted category, for example, module 306 communicates with module 608 to determine if there exists an exception for this web site. If, for example, a child is usually limited from shopping on e-commerce sites, the exception module may have an indication for church or school web sites that, effective, could be classified as e-commerce if items are sold over the Internet. A school web site, therefore, would not be restricted from selling supplies or textbooks even though e-commerce sites are a prohibited category.

The reporting module tracks all access attempts, an indication as to whether the access was allowed, total access time for specific web sites as well as categories of web sites, and generates reports that may be produced in any form to the administrator. Blocking module 312 thus blocks or allows access based on determinations made in association with modules 302, 304, 306, and 308.

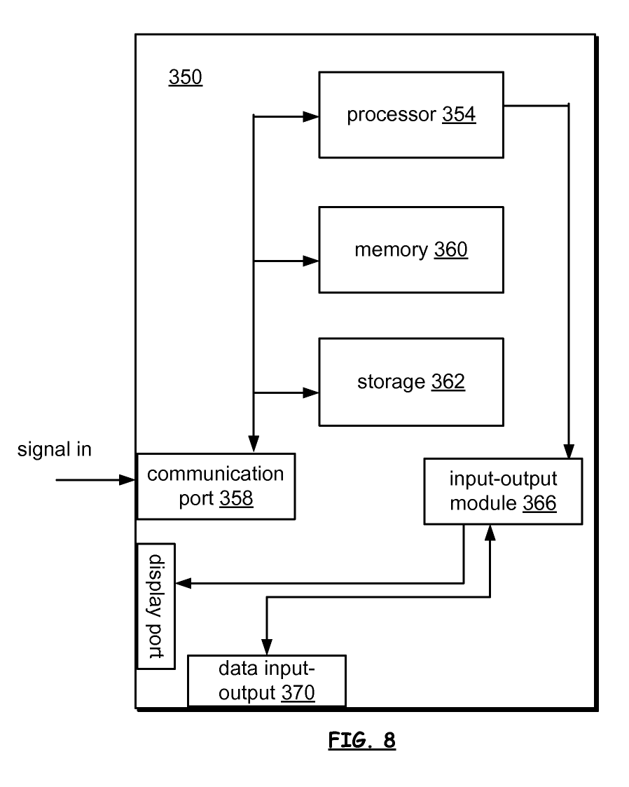

FIG. 8 is a device according to one embodiment of the invention. The processor executes computer instructions stored either in memory or in storage to execute the steps and logic described herein. The device communicates over the Internet through the communication port and produces display signals and audio by way of an input-output module. Additionally, data stored to an external hard drive or received in an input device such as a microphone or keyboard is received through a data input-output port and an input-output module.

More specifically, device 350 includes a processor 354 that communicates through a communication port 358. Operation is defined by instructions stored in memory 360 and/or storage 362. Storage 362 comprises any storage device, such as a hard disk drive, that stores any type of data including usage and access restrictions on a per user basis. Processor 354 further communicates with input-output module 366 that is operable to communicate with data input-output devices (e.g., external devices such as a keyboard, a mouse, a Bluetooth™ peripheral, a storage device, or a display (to list just a few examples) through a data input-output port 370.

In operation, the instructions define logic to create the modules of FIG. 8 to operate according to the identified methods steps of the methods of FIGS. 5 and 6. Generally, the instructions support the creation of usage monitoring parameters for one or more users, the monitoring in accordance with the defined parameters, enforcing usage access restriction in accordance with the defined parameters, and specified reporting.

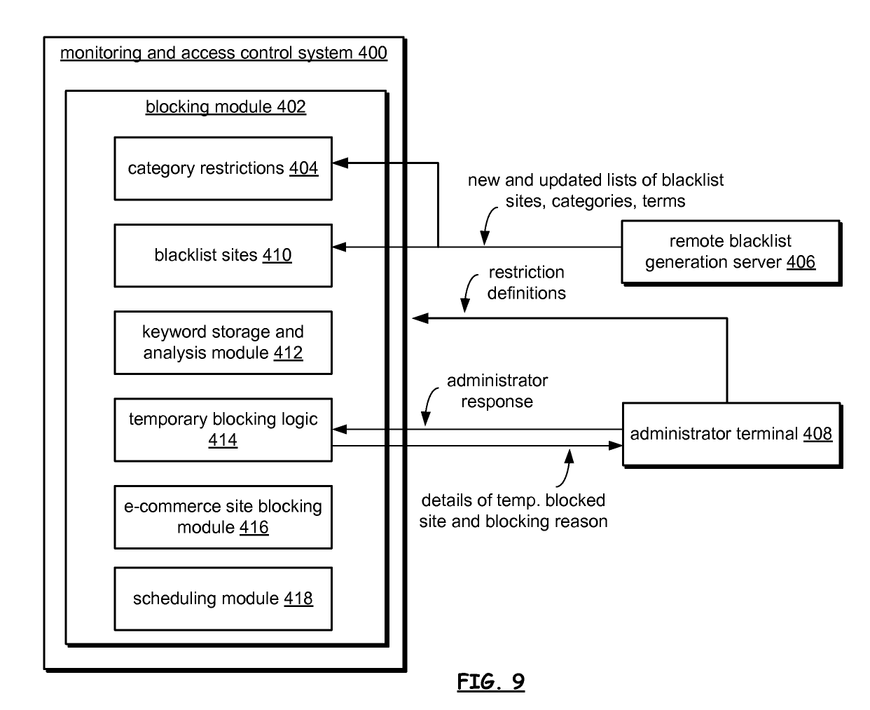

FIG. 9 is a functional block diagram of a monitoring and access control system 800 that includes a blocking module 402. Blocking modules 402 includes a category restrictions module 404 that is operable to maintain a list on a per user basis of restricted categories. The restricted categories may be specified by administrator selection on an administrator terminal 406 or by a received blacklist from a remote server 408. For example, a display page is generated on the administrator terminal 406 giving the administrator options for setting up access restrictions. The administrator selections are transmitted as an administrator response to the monitoring and access control system 400. The restricted categories are stored in category restrictions module 404 that is further operable to update the list of restricted categories based on receiving updated inputs from either server 406 or terminal 408.

Module 402 further includes a blacklist sites module 410 that is similar to module 404 except module 410 maintains a list of blacklisted web sites. Module 402 also includes a keyword storage and analysis module 412. Module 412 is operable to evaluate a web site that a user seeks to access and to analyze content on the web site for specified search terms and or indications of prohibited web site category. A temporary blocking logic module 414 is operable to deny access to the web site based on an indication from the module 412 that the web site is suspected to be a prohibited type of web site. Accordingly, module 414 transmits details of the temporarily blocked web site and a reason for blocking the web site to administrator terminal 408. Based on an administrator response, blocking logic module 414 either grants access or sends updates to at least one of modules 410 and 404 to update their information to include either a new category, term, or web address.

Module 402 also includes an e-commerce site blocking module 416 that is operable to detect all we sites that sell products and services and to allow access or block access according to restriction definitions specified by the administrator terminal 408. For example, all e-commerce sites either may be restricted or, alternatively, just portions of such sites (e.g., secure payment processing pages to block purchases). Additionally, e-commerce site blocking module 418 is operable to identify and prevent access to subscription based web sites including web sites that provide free downloads but that require a regular membership fee.

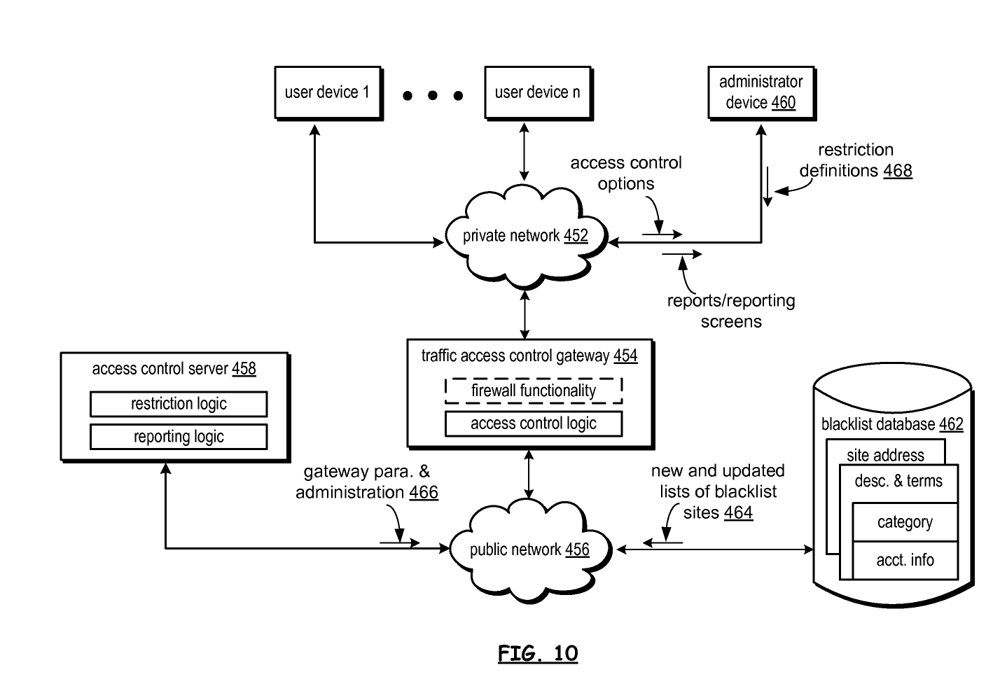

FIG. 10 is a diagram of a network 450 according to one embodiment of the invention. As may be seen, a private network 452 couples a plurality of user devices 1-n and an administrator device. Private network 452 couples each of these devices to a traffic access control gateway 454 that executes access control logic based on gateway parameters and administration to limit access to a public network 456. The access control logic may be specified or received from an access control server 458 and/or from an administrator device 460. These gateway parameters include restricting access by time, usage amount, web address, web site category, web site search terms, etc. Gateway 454 thus. A blacklist database 462 provides new and updated lists 464 of blacklist sites, terms, descriptions, and categories. The gateway 454, the access control server 458, and the blacklist database 462 all communicate over a public network 456 (e.g., the Internet).

It should be understood that the access control functionality may be partitioned in a variety of manners. For example, in one embodiment, access control server 458 includes all of the corresponding functional logic for determining what is to be restricted or blocked. Thus, server 458 transmits signal 466 that includes gateway parameters and administration control messages or commands to traffic access control gateway 454. In this embodiment, the administrator restriction definitions specified in signal 468 and the lists 464 of the blacklist database are transmitted by way of private and/or public networks to the access control server which then sends specific blocking instructions in signal 466 to the gateway 454. Any of the modules described beforehand in relation to FIGS. 5-8, for example, may be disposed within the gateway 454. Accordingly, some of the communications may be transmitted to the gateway 454 instead of the access control server to correspond with such operation of the modules therein.

Referring to the blacklist database 462, examples of the types of information that the database transmits in signal 464 either to the access control server or the gateway includes lists of specific sites as well as categories of web sites such as adult, shopping including e-commerce, sports, aggressive, part nudes, beer/liquor information and/or sale, dating, gambling, drugs, guns, hacking, naturism (promotion of nude lifestyle), on line auctions, on line games, pornography, sexuality, social networking, spyware, violence, warez (illegal pirated software), white lists (endorsed sites), chat rooms, subscription and access fee related sites, e-commerce sites.

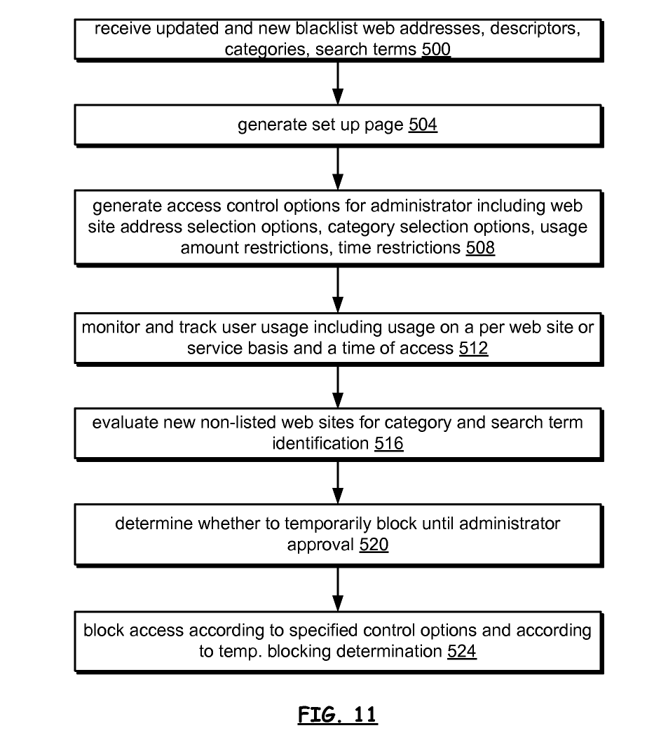

FIG. 11 is a flow chart of a method according to one embodiment of the invention. The method includes receiving updated and new blacklist web addresses, descriptors, categories, and search terms (500). The method also includes generating a set up page (504). The setup page is generated for display on the administrator terminal to allow the administrator to make usage restriction selections. Thus, the method includes generating access control options for administrator including web site address selection options, category selection options, usage amount restrictions, time restrictions (508).

Thereafter, the method includes monitoring and tracking user usage and allowing/denying access (512). This step includes monitoring usage on a per web site or service or category basis and a time of access of such web site, service or web site category. As a part of monitoring tracking usage and allowing/denying access, the method includes evaluating new non-listed web sites for category and search term identification (516) and, based on such evaluation, determining whether to temporarily block access until administrator approval (520). Finally, the method includes blocking access according to specified control options and according to a temporary blocking determination (524) until approval or denial is received from an administrator terminal or account.

To illustrate the above operations in a family setting, though the same applies to other social groups such as work places, access may be restricted by the gateway device to limit what times a user can access a web site or a category of web sites. For example, socialization web sites may be limited to the hours of 4-5 p.m. as specified within a defined time window for each weekday and in the evenings of weekend nights. Thus, if the parent selects such a category with such time restrictions, any web site that may be classified in the selected category will be restricted for the specified user. Additionally, the method includes monitoring a total amount of time that particular categories of websites are being accessed by the user to limit total usage for such categories of web sites. The same type of operation regarding time of access and total usage may also be applied to specific web sites as identified by their addresses.

When a restricted user attempts to access a site that is not an approved web site (that was previously identified as allowable even if with usage restrictions) and that is not in a restricted category or list for the user, one of the gateway device and or the network access controller evaluates the web site content to attempt to determine if the website is one of a prohibited or restricted category. If so, access to the web site is temporarily blocked, a request is sent to the administrator with information about the website and an indication of why the web site was temporarily blocked. The blocking continues until a response is received from the administrator. Thereafter, based on the administrator response, access is allowed or the web site is added to one or more lists of web sites that have access restrictions.

The system and method allow, therefore, a parent or administrator to specify specific sites that are to be blocked in blacklist. Additionally, the items in the blacklist may be supplemented by blacklists that are provided by one or more remote servers that are associated with services that search for and identify specific sites of prohibited categories. The parent or administrator thus creates or defines users with permissions per user. The permissions or restrictions thus can specify a total amount of time that is allowed to access the Internet, a total amount of time that a category of website can be accessed, or a total amount of time that a particular website may be accessed. Similarly, windows of access time may be defined for categories of web sites or for specific web sites. Any of the examples where a usage amount is specified as a total amount of time may readily be replaced with a time window to allow entry of a time range for which access to the specified web site or web category is allowed. Additionally, specific blocking rules can be specified wherein a defined access is blocked during specified periods. The system and method also support sending reports or generating display screen with report information that allows a parent or administrator to review total usage of the user including attempted access to restricted sites or categories of web sites. This would allow, for example, a parent to determine if a child is spending too much time in a chat room or on commerce web sites shopping.

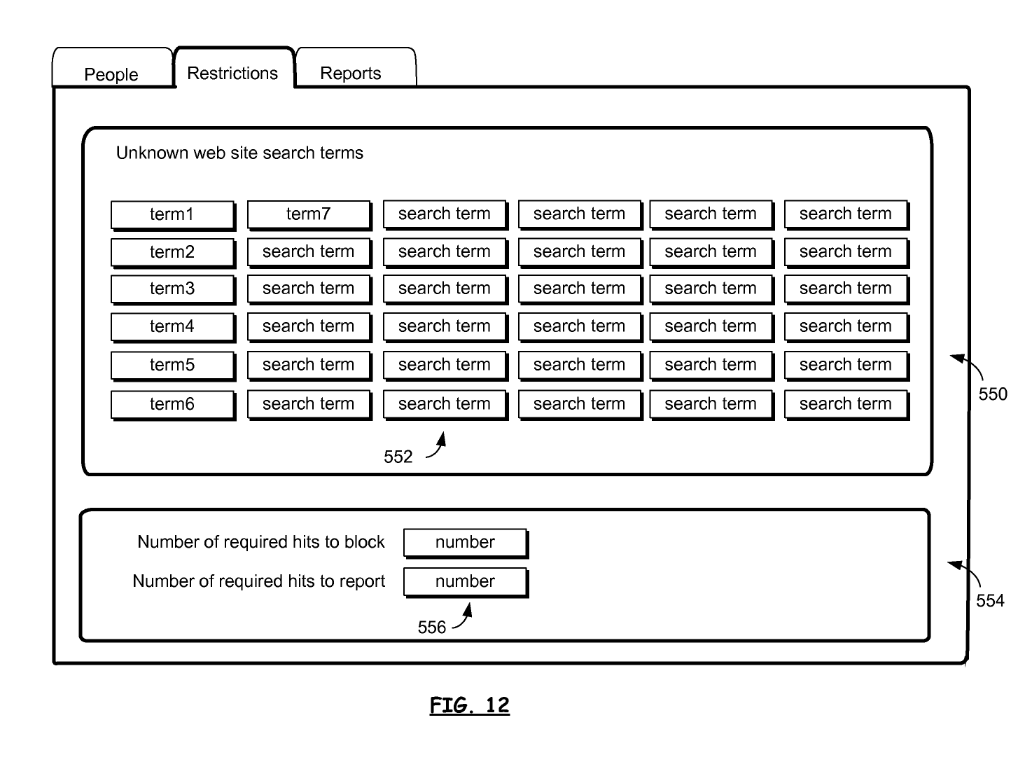

FIG. 12 is diagram that illustrates an example display of restriction definitions page elements that allows an administrator to specify search terms and associated logic for unknown web sites that a user is attempting to access. A window 550 includes a plurality of GUI fields 552 to enable an administrator to enter search terms for unknown web sites. While the illustrated embodiment shows a plurality of GUI fields in which search terms may be entered, it should be understood that any mechanism for enabling an administrator to enter search terms for unknown web pages or web sites is considered to be within the scope of the invention. Additionally, as may be seen, a window 554 enables an administrator to specify how many occurrences (“hits”) are required to trigger blocking for an unknown web site. Thus, the administrator enters a number in the corresponding GUI field of column 556. An unknown web site is one whose address is not listed for regulation or blocking. In one embodiment, an unknown web site may also be one whose category cannot be determined. The administrator can also specify how many hits are required for the web site to be reported to the administrator to enable the administrator to review the web site to determine whether the site should be regulated or blocked.

In operation, if an apparatus such as a gateway device, receives an access request for an unknown web site, the apparatus analyzes web content on the requested web page or web site to look for the specified search terms. Accordingly, the apparatus provides some preventive regulation for newly discovered web sites whose addresses are not initially known.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

What is claimed is:

1. An apparatus, comprising:
a communications interface operable to communicate with another device via a plurality of networks including at least one wireless network;
memory; and
processing circuitry coupled to the communications interface and the memory, wherein the processing circuitry, in combination with the communications interface and memory, is operable to:
receive usage restrictions from an administrator terminal that specify allowed usage by:
at least one of web address and type;
amount per specified period;
verify authorization to define parameters for restricting usage in accordance with the received restriction parameters;
store the received usage restrictions; and
regulate access to a specified device or network based on the usage restrictions.

2. The apparatus of claim 1, wherein the processing circuitry receives usage restrictions that limit total Internet usage in relation to a specified day of the week.

3. The apparatus of claim 1, wherein the processing circuitry receives usage restrictions that limit total Internet usage for accessing restricted sites in relation to a specified day of the week.

4. The apparatus of claim 1, wherein the processing circuitry receives usage restrictions that define restricted sites by web address or name in relation to a specified day of the week.

5. The apparatus of claim 1, wherein the processing circuitry receives usage restrictions that define blocked sites by web address or name in relation to a specified day of the week.

6. The apparatus of claim 1, wherein the processing circuitry receives usage restrictions that limit total Internet usage for accessing web sites by at least one defined category in relation to a specified day of the week.

7. The apparatus of claim 6, wherein the processing circuitry receives one or more web site addresses in relation to each defined category.

8. The apparatus of claim 1, wherein the processing circuitry receives a list of blacklisted web sites from a remote blacklist database and blocks all access attempts to the blacklisted web sites.

9. The apparatus of claim 1, wherein the processing circuitry analyzes the requested web site content to determine whether to block access.

10. The apparatus of claim 9 wherein the processing circuitry determines whether to block access based on specified search terms identified within the web site content.

11. The apparatus of claim 9 wherein the processing circuitry determines whether to block access based on a specified number of occurrences of the specified search terms.

12. The apparatus of claim 9 wherein the processing circuitry determines whether to block access based on a determined web site category.

13. The apparatus of claim 9 wherein the processing circuitry receives defined reporting parameters and generates reports to report usage according to the defined reporting parameters.

14. The apparatus of claim 1 wherein the processing circuitry receives defined reporting parameters and generates reports to report specified web site access attempts according to the defined reporting parameters based on at least one of specified web addresses and categories.

15. A method, comprising:
generating graphical user interface (GUI) setup pages for display on an administrator terminal that include usage restriction parameter fields and time restriction parameter fields in relation to days of a week;
receiving administrator access control selections that include at least one of the usage restriction parameter field selections and time restriction parameter field selections in relation to the days of the week; and
monitoring and regulating Internet access to correspond with the administrator selections.

16. The method of claim 15 further including receiving, from a blacklist database, at least one of blacklist web sites and blacklist categories and monitoring and blocking Internet access to block access to web sites listed specifically or by category.

17. The method of claim 16 further including generating the GUI setup pages to include the blacklist web sites the blacklist categories for selection by the administrator.

18. The method of claim 9 including generating GUI setup pages to support administrator selection and entry of web site categories for regulation or blocking.

19. The method of claim 9 including generating GUI setup pages to support administrator selection and entry of search terms for unidentified web sites.

20. The method of claim 9 including controlling user access based on at least one of administrator selected web sites or web site categories.

21. A method, comprising:
receiving a web site access request from a specified user;
determining whether the web site is a blocked web site and if so, blocking access to web site; and
determining whether the web site is a usage restricted web site and, if the web site is a usage restricted web site:
determining whether a daily usage restriction for the web site address has been exceeded;
blocking access if the daily usage restriction has been exceeded; and
allowing access if the daily usage restriction has not been exceeded.

22. The method of claim 21 further including:
determining whether a daily usage restriction for a web site category corresponding to the web site address has been exceeded;
blocking access if the daily usage restriction has been exceeded based on the web site category; and
allowing access if the daily category usage restriction has not been exceeded.

23. The method of claim 21 further including generating usage reports according to administrator specified reporting parameters.

24. The method of claim 21 further including determining if the requested access is within a permitted time window.
